(19) United States
(12) Patent Application Publication
(10) Pub. No.: US 2008/0126519 A1
(43) Pub. Date: May 29, 2008

(54) Automatic Assignment Of A Network Id

(75) Inventors: Martin Knespel, Vienna (AT); Adolf Proidl, Vessem (AT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/573,547

(22) PCT Filed: Sep. 27, 2004
(86) PCT No.: PCT/IB04/51864

§ 371 Date: Mar. 27, 2006

(30) Foreign Application Priority Data
Sep. 30, 2003 (EP) 03 103 617.1

(51) Int. Cl. G06F 15/173

(52) U.S. Cl. 709/220

(57) ABSTRACT

For the automatic assignment of an identification (SSID2) which designates a network (1), network server means (3) and access means (4) connected to these network server means are used, wherein the access means (4) are set up for communication with at least one network client (6) and the network server means (3) are operated to generate a network (1) which is defined by a provisional, preset identification (SSID1) which is known to the network client (6), and wherein a communication is made between the network server means (3) and the network client (6) via the access means (4), and the network server means (3) send to the network client (6) a new identification (SSID2) which they have generated, which is used for final designation of the network (1).

The invention relates to a method for automatic assignment of an identification which designates a network, said network using network server means and access means associated with these server means, said access means being set up for communication with one or more network clients.

In a similar manner the invention relates to a system for automatic setting-up of a network with an identification, with network server means with which network access means are associated, and with one or more network clients, wherein the server means have network driver means to operate the network.

Networks, in particular wireless networks, are provided with an identification so that the network concerned may be identified and selected. These identifications are described as SSIDs (SSID—Service Set Identifier), and such an identification is comprised of a character string which is unique for each network. Facilities using the same SSID belong to the same network.

Such networks are becoming of growing importance, since “private” networks are more and more often being set up for home applications. For such—wireless—private networks (so-called WLAN networks: WLAN—Wireless Local Area Network), radio network standards such as in particular the IEEE 802.11.b standard, have already been developed. For example the article by Th. Zahriadis et al., “Multimedia home networks: standards and interfaces”, Computer Standards & Interfaces, Vol. 24, No. 5 (November 2002), P. 425-435, gives various examples of such home networks, in which normally a personal computer (PC) is used as network server means and in which the network clients, i.e. client devices, are formed by typical consumer electronic equipment such as CD players, DVD players, radio sets, video recorders, television sets, etc. Other examples of network clients are kitchen appliances, but also actuators for climate control equipment in a household, for example for the adjustment of blinds. Here it is generally laborious for a network to be established or selected from the network client side. Essentially it is possible, even if there are several overlapping networks in existence, to determine which network should be used by entering a suitable SSID into the network client. The network may also be selected by showing a list of possible SSIDs on a display on the network client, with the user then selecting the desired identification and thus the desired network. Even if these procedures as described above appear relatively simple, it may be that a user does not know which identification he should enter or select, and how this is to be effected, especially if one considers that the user generally has no specialist knowledge in the field of network technology. There is also the fact that settings on consumer electronic equipment (also known as CE equipment: CE—Consumer Electronic) have only very limited scope for such input of characters. Above all, CE equipment usually has limited resources, i.e. low memory capacity, slow processors, cost-optimized hardware, etc. so that the input or selection of network SSIDs is complicated and for this reason there is a desire for a simpler but no less reliable method for the input or selection of network identification.

On the other hand it is already known from EP 1 241 838 A2, when connecting a computer into a wireless network, to use first of all in an ad-hoc mode an ad-hoc SSID, after which connecting into the desired network finally takes place with the assigned SSID, with the desired SSID being selected from a preset list. Such “manual” selection of an SSID from a list presents no problem on a computer but, as mentioned above, is at the least laborious in the case of entertainment electronics equipment, if not impossible.

It is now an object of the invention to propose a method or a system as described above, so that a network identification (SSID) may be made as far as possible automatically, without intervention by the user. At the same time it should be nevertheless ensured, with a high degree of probability, that the correct network is selected (and not for example a network installed in a neighboring dwelling), and specifically irrespective of whether or not the network is being configured for the first time or whether a new network client is being brought into the network.

To achieve this object, according to a first aspect of the invention involving a method for the automatic assignment of an identification which designates a network, features according to the invention are provided so that the method may be characterized as follows:

Method for the automatic assignment of an identification which designates a network, said method using network server means and access means associated with these server means, said access means being set up for communication with one or more network clients, wherein the network server means are operated to generate a network which is defined by a provisional preset identification known to the network client, wherein communication is established between the server means and the network client via the access means and the server means send to the network client a new identification generated by them, which is used for final designation of the network.

To achieve the object, according to a second aspect of the invention involving a system for the automatic setting-up of a network with an identification, features according to the invention are provided so that the system may be characterized as follows:

System for the automatic setting-up of a network with an identification, with network server means to which access means are connected, and with one or more network clients, wherein the network server means have network driver means to operate the network with a provisional identification, together with further identification generation means to generate an identification to be used for the final network identification, and wherein the network client has storage means for the storage of at least one provisional identification, search means to search for a network with this provisional identification, and sending and receiving means to receive the identification generated by the network server means, together with storage means to store the identification received from the network server means.

Thus, in the technology according to the invention, a network with a provisional identification is first set up, this provisional identification being known to the network client from the outset. This provisional identification will not yet as a rule be a unique, unambiguous identification but will be adequate to set up provisionally a network with the network server means and the network clients, for the short-term. As soon as the network is in existence the network server means, i.e. in particular a PC, generate an identification intended for the final designation of the network, and specifically preferably as a random number or pseudo random number, for example by providing that, a certain period of time after the creation of the provisional network, the clock time in seconds and tenths of seconds is used as random number for the identification. This current identification is sent via the provisional network to the network client (or to the network clients, if there is more than one), and when this current identification has been received by the network client, the provisional network with the provisional identification is dismantled, and the new network based on the new final identification is set up by the network server means. The current final identification is stored both by the network client and in the network server means.

The network is preferably a wireless network, a WLAN, wherein the access means linked to the network server means are also designated as access point or AP for short. For such a wireless network, i.e. in particular a radio network, the access means are defined according to a common standard, in particular so far as configuration and transmission protocols are concerned, so that this aspect need not be considered further. Within the scope of the invention it is however particularly advantageous if, for additional enhancement of security, after the sending out of the identification intended for final network designation, the network client returns this identification received from the network server means back to the network server means in a slightly modified form, for example with an addition, after which the identification thus modified is used as final identification for the network. For example the network client may add to the identification sent out by the network server means, characters corresponding to its model type. In this way the final network identification is made virtually unmistakable.

In order to avoid, in setting up the provisional network with the provisional identification, any conflicts with networks in the neighborhood, it is advantageous for the network client to be connected at the start of setting-up the network in the vicinity of the access means, i.e. the access points, and for these access means to be operated in an operating mode with low transmitting power, so as to avoid interference with other networks.

For reasons of security it has also been found advantageous for the network server means to generate the new identification only after they have detected the network client with the provisional preset identification.

As a rule it is sufficient if only a single provisional identification is preset. However it is also possible to provide for several provisional identifications to be stored in a list in the network server means and either to select from this group of identifications the identification which matches the network client or, if this group of identifications is known to the network client, for the network server means to select and send out the provisional identification, preferably according to the random number principle, from this group of identifications.

The technology according to the invention is also suitable in an advantageous manner for the adding of new network clients to a network which has already been set up with one network client. In this case the server means set up a provisional network with the identification known to the new or additional network client. The network server means then inform the new network client of the final identification already defined in the manner described above, and the network is re-established with this final identification to include the new network client. Here too it is once more expedient at the start for the new network client to be connected close to the access means, and for these access means to be operated in a mode with low transmitting power.

It has also proved to be advantageous, in re-establishing the network server means, for the network client to be reset to the provisional, preset identification, under which the network server means set up the provisional network, after which the network server means generate a new final identification which is sent to the network clients. The network is then operated with this identification.

Finally, in order to generate the final identification at random or with pseudo random numbers, it is of advantage when the network server means have identification generation means in the form of random number generation means, for the generation of at least pseudo random numbers.

These and other aspects of the invention are apparent from and will be elucidated with reference to the embodiments described hereinafter.

In the drawings:

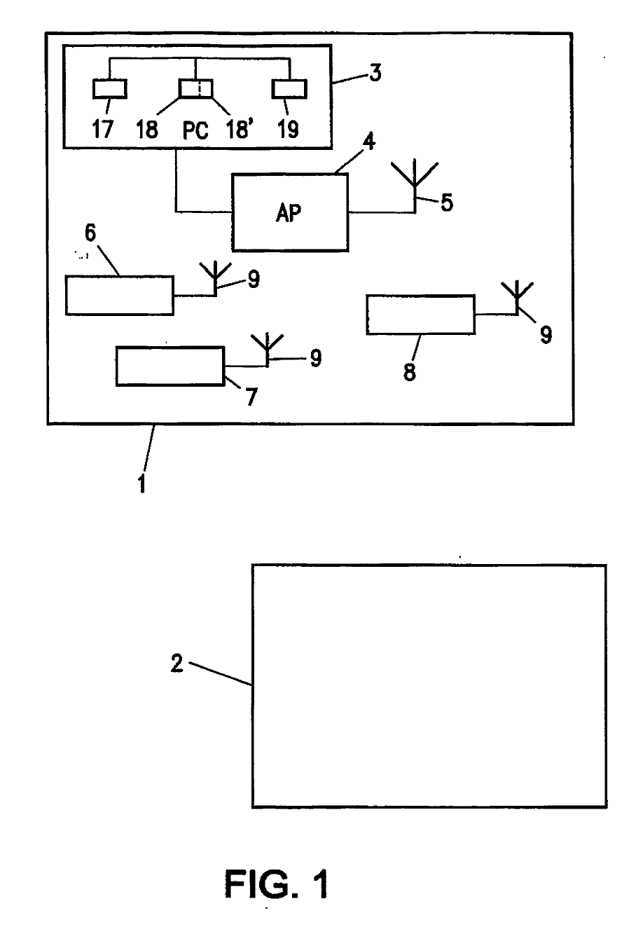

FIG. 1 shows in schematic form a network configuration with for example a PC as network server means, access means linked to the former, and three network clients.

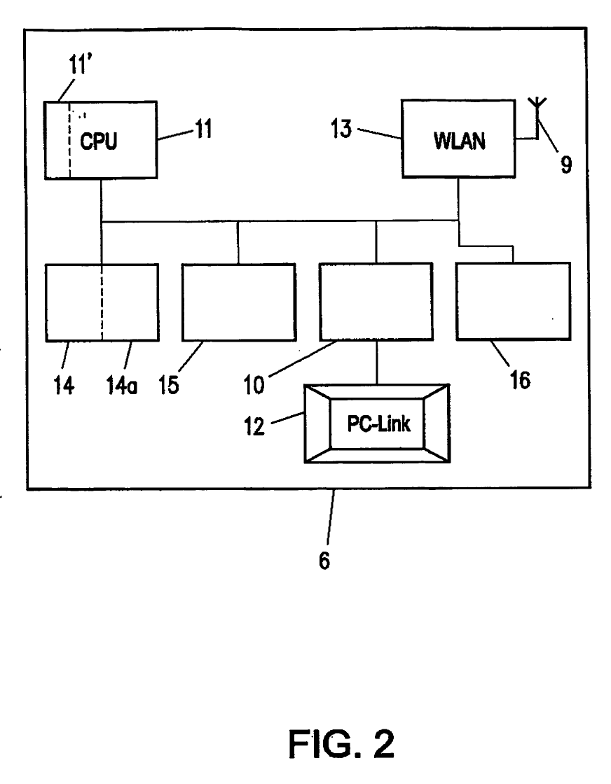

FIG. 2 shows schematically in a block diagram a typical configuration of a network client.

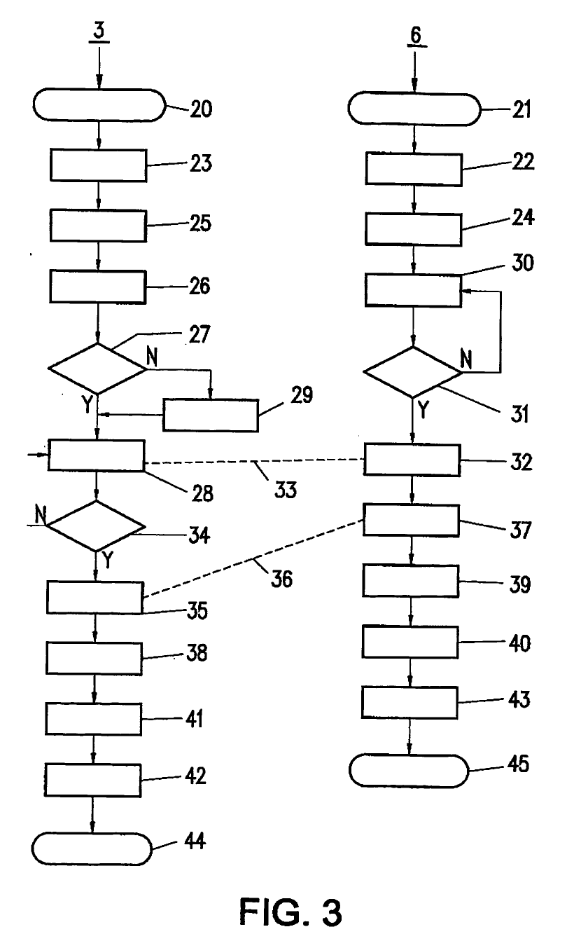

FIG. 3 shows a flow chart illustrating in two parallel sequences the procedure during initial installation of a network, and specifically on one side the sequence on the part of the network server means, and on the other side the sequence on the part of the network client.

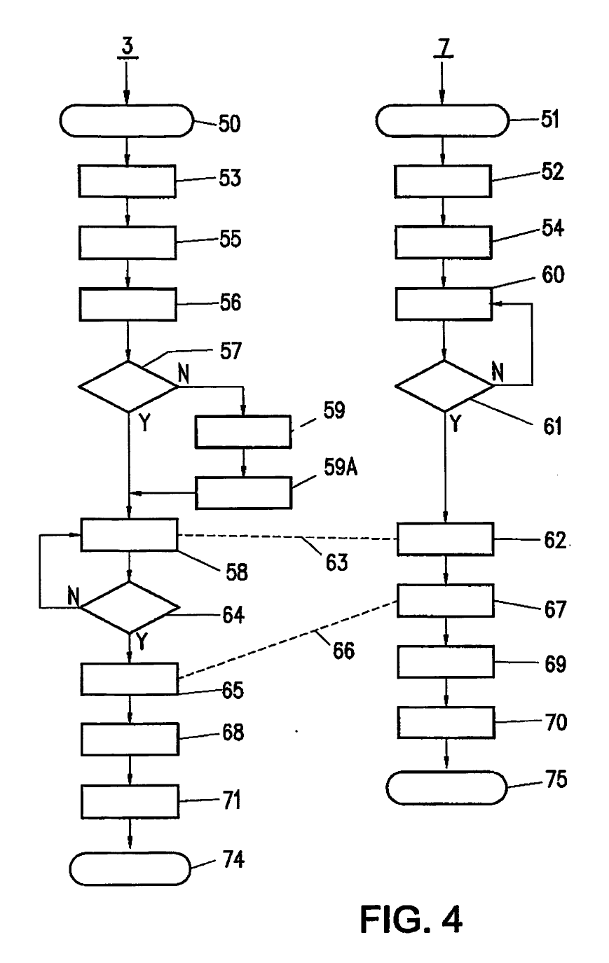

FIG. 4 shows in a corresponding flow chart the sequences during the installation of an additional network client in an already existing network, wherein once again one side shows the sequence on the part of the network server means, and the other side shows the sequence on the part of the additional network client.

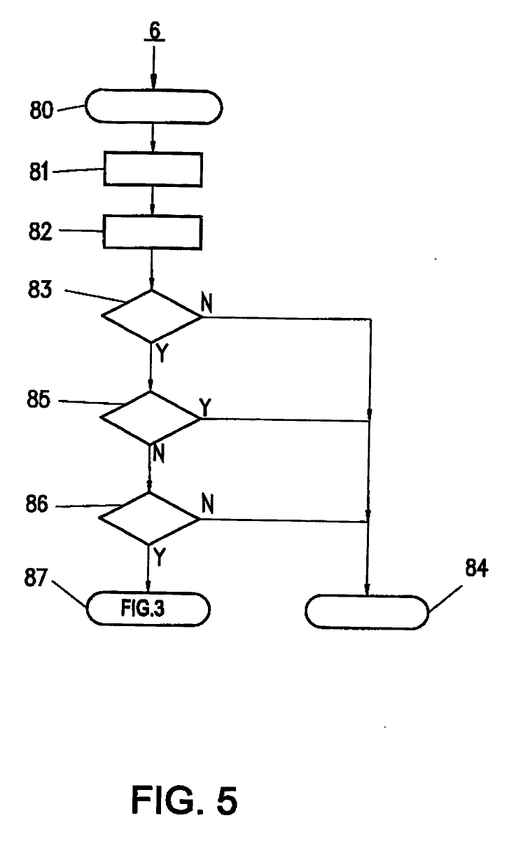

FIG. 5 shows a simplified flow chart illustrating the procedure for the re-installation of network server means, i.e. for example PC software.

FIG. 1 shows a network 1 in schematic form within rectangular boundary lines, and also indicated is a second network 2 which in the present example has sufficient clearance from network 1 but may also overlap network 1. Each network 1, 2 is for example a WLAN network (WLAN—Wireless Local Area Network—wireless local network). Other networks are however also conceivable, and in particular there may also be a cabled network (Wired Network, LAN). Each network 1, 2 has a separate, unique identification, the so-called SSID) (SSID—Service Set Identifier), and via this identification, hereafter also described as SSID for short, a network such as network 1 may be selected for the logging-on of a network client.

The network 1 considered in detail here by way of example has network server means 3, for example in the form of a PC (Personal Computer). Connected to these network server means 3 are access means 4, a so-called access point, also designated AP for short, wherein these access means 4 have an aerial 5 in order to effect the wireless communication with network clients 6, 7, 8 . . . in the network 1. Each network client 6, 7, 8 . . . is in turn equipped with an aerial 9 for wireless communication.

The access means 4 form the transition between the wired portion of the network 1 and the wireless portion thereof, and may be regarded substantially as a “radio station”. Such access means 4 are prior art and require no further explanation here. These access means 4 may be connected to the network server means 3 for example via an USB interface (USB—Universal Serial Bus), but it is however also conceivable for the access means 4 to be integrated directly with the network server means 3, for example in a notebook computer. In the case of stationary PCs it is usual for the access means 4 to be provided separately from the PC.

The network server means 3 may already contain in the operating system suitable network software in general, with network driver means for the network 1 and for the access means 4, or else suitable software may be loaded for operation of the network 1, with the access means 4 being connected to the network server means 3 either before or after this takes place. It is also known for the operating systems of PCs themselves to contain already a general network driver, so that in setting-up a special network it is necessary to load only additional software for the recognition of network clients. As mentioned above, this involves basically known technology, also including the definitions, configurations and transmission protocols, so that no further details are required here.

In the case of home networks, for which the present invention is preferably intended, the network clients 6, 7, 8 . . . are typically entertainment electronic devices such as e.g. video recorders, CD players, DVD players, televisions, radios, cassette recorders, etc. At the same time, though, household appliances, drives for blinds, light switches (dimmers), etc. may also be involved. Such equipment has only very limited scope for inclusion in a network, so far as the input of information and the retrieval of data are concerned. As a rule they have only slow processors and small memories and are in principle designed simply to perform their own function—as video recorder, CD player, etc. It has therefore to date been difficult to integrate such equipment into a network as network clients, which would involve the input of the necessary network identification (the SSID) to log on to the network concerned. With the technology described below, such inputs to network clients may be dispensed with, and only minimal action involving the network clients is required.

FIG. 2 shows by way of example in a block diagram the configuration of such a network client 6. The network client 6 contains the functional unit 10 typical for this equipment, i.e. for example in the case of a video recorder a tape drive with associated electronics, in the case of a CD player a CD drive, etc., as a rule connected to a signal pulse generator and, derived from the latter, a clock. The network client 6 also contains a central processor unit (CPU) 11 which undertakes not only control tasks typical for the function of the network client 6, but also control tasks involved in participation in the network 1 (see FIG. 1), while at the same time comprising in particular search means 11′ to search for a network 1 with preset identification. For incorporation in the network 1, the network client 6 has a button “PC-Link” 12, connected for example via the functional unit 10 or else directly to the central processor unit 11; and by which the setting-up of the network 1 in conjunction with the network server means 3 (see FIG. 1) is initiated in a manner which is otherwise automatic. For connection to the network 1, the network client 6 also contains suitable sending and receiving means 13, e.g. a WLAN card. The network client 6 also contains storage means 14, 14a for the storage of a provisional and a final identification, while these storage means 14, 14a also contain a RAM memory and a ROM memory. The network client 6 also contains a separate memory 15 for the serial number of the network client 6, for information relating to model, date of manufacture and other data. Finally the network client 6 also has additional code generation means 16, the purpose of which will be explained in detail below. It may just be mentioned here that these additional code generation means may be set up to generate pseudo random numbers, wherein they generate a pseudo random number e.g. on the basis that an indication of time, e.g. a hundredth or a thousandth of a second after switching-on of the network client 6 is taken, or that a fixed program is contained which repeatedly generates random numbers (“pseudo random numbers”), as is essentially known from the prior art. A further option is for the “random number” to be calculated as a code dependent on the respective network client 6, for example from the equipment serial number.

Comparable random number generation means are also contained in the network server means 3 according to FIG. 1 as identification generation means 17, generating in a similar manner a random number or pseudo random number for the production of an SSID, as explained in more detail below. Also provided in the network server means 3 are a CPU 18, the network driver means 18′, and storage means 19, as also shown schematically in FIG. 1.

It is now intended to explain the procedure for initial installation of a network, such as network 1 according to FIG. 1, with the aid of FIG. 3. Here it is assumed that a PC is provided as network server means 3, and that there is a CE device as network client 6, wherein the network server means 3 is also assigned as access means 4 an access point with aerial 5, and wherein the network client 6 has a corresponding aerial 9 so that wireless communication is possible. The configurations and parameters required for this purpose are standard, and the description which follows is therefore limited to the features typical for the present procedure in determining the SSID.

The left-hand side of FIG. 3 shows the sequence for the network server means 3, and the right-hand side shows the sequence for the network client 6, with fields 20 and 21 respectively providing starting steps for the network server means 3 and network client 6 respectively. According to field 22, the network client 6 is brought as close as possible to the access means 4, while the access means 4 are also operated in a sending mode with the lowest possible power so that neighboring networks, e.g. in adjacent dwellings, are not subjected to interference. In itself, this close proximity of the network client 6 to the access means 4 is not absolutely essential, but it is recommended, also so that the network client 6 “finds” its own access means 4 as communication partner without difficulty. In this connection it should also be remembered that private networks, operating with unlicensed frequencies, quite generally use narrow sending frequency bands and low transmitting power.

In accordance with fields 23 and 24 respectively, the network server means 3 and network client 6 respectively are switched on. At the same time as the network client 6 is switched on, the “PC-Link” button 12 (see FIG. 2) is also pressed, to start the fixed programmed or “wired” element of the installation sequence on the part of the network client 6.

The network software is then—if necessary—installed in or loaded to the network server means 3. In this connection, the operating system of the PC forming the network server means 3 may already contain suitable network driver means 18′, but separate software may also be installed by means of a CD-ROM supplied with the network client 6. In FIG. 3 the use of such a CD-ROM is shown in field 25, while the loading of network driver software is shown in field 26. Right from the start, the network client 6 contains in the storage means 14 (see FIG. 2) a provisional network identification, here referred to by way of example as SSID1. This SSID1 is also contained in the CD-ROM/network driver software and is thus known to the network server means 3 for this reason.

In accordance with an inquiry field 27 in FIG. 3, the network server means 3 now search for a network with this identification SSID1 and, if such an SSID1 network already exists, the sequence moves on to field 28. If however no such network with SSID1 exists, which for a first installation is to be expected, then the network server means 3 set up the desired network in accordance with field 29 and on the basis of the network driver software loaded into them, in an essentially usual manner.

According to field 28 referred to above, the network server means 3 then search their environment for a network client 6.

In parallel to this, the network client 6 searches, in accordance with field 30 in FIG. 3, for a network with the identification SSID1—stored in the storage means 14—and in field 31 an inquiry is made of network client 6 as to whether or not such a network with SSID1 has been found. If not, the sequence returns to field 30 and the search for a network with SSID1 continues. If the answer is yes, then in field 32 of the sequence, logging-on to the network with identification SSID1 takes place, and once again in a substantially normal manner. This logging-on in accordance with field 32 involves synchronization with the search for a network client 6 as shown in field 28, as indicated schematically in FIG. 3 by a broken line 33 between fields 32 and 28.

In the sequence for the network server means 3 (left-hand side of FIG. 3), an inquiry field 34 may now be provided, to inquire as to a possible elapse of time (“timeout”). If a preset period of time—e.g. 3 min,—has not yet elapsed, then the sequence returns to field 28 and the search for a network client 6 continues. When the time has elapsed (output Y of field 34 in FIG. 3), the network server means 3 generate with the aid of the identification generation means 17 a (pseudo) random second network identification, which is here called SSID2, and this SSID2 is sent to the network client or clients 6 in network 1. This is shown in a field 35 in FIG. 3 and synchronized with this—as indicated by a broken line 36 in FIG. 3—a phase as shown in field 37 operates in the network client 6, in which such a second SSID2 is expected, finally received and stored in the storage means 14a. Similarly the so-called MAC address of the PC forming the network server means 3 and of the access point forming the access means 4 are also now stored (MAC—Media Access Control—the lowest layer in a network directly above the physical layer, wherein here in each case a worldwide unique number is assigned, for example a product code, a consecutive number, etc.).

The network server means 3 then close down the network with SSID1, i.e. the provisional identification, see field 38 in FIG. 3, and in accordance with field 39 in FIG. 3, the network client 6 logs off from this network with SSID1. In accordance with field 40 of FIG. 3, the network client 6 then waits if necessary for a network with the identification SSID2 and logs on to this network SSID2 as soon as it has been set up by the network server means 3. This new network with SSID2 is set up in detail by the network server means 3 in accordance with field 41, following field 38 (dismantling of the network with SSID1), and in accordance with final fields 42, 43, the network server means 3 and the network client 6 store the SSID2, followed in each case by a final step as shown in fields 44 and 45 respectively.

The provisional SSID1 referred to above is a predefined, fixed identification which is used only until the final identification for the network 1 has been generated. In this connection it is also quite conceivable to provide a group of predefined provisional identifications SSID1, with one SSID1 being selected from this group in the specific case, assuming that all devices involved recognize this group of SSID1s. In the search for a network with SSID1, the network client can then automatically go through this group. Here it is more than unlikely that at exactly the same time in a neighboring dwelling a similar device is being brought into operation and a network with the same provisional SSID1 is being set up, so that reciprocal interference in this context is highly improbable. The second SSID2, on the other hand, based on a random number or pseudo random number, is virtually unique, so that any conflict with neighboring networks in the future may be ruled out with a high degree of probability.

All the steps described above operate fully automatically, i.e. apart from switching-on of the equipment, loading of the program into the network server means 3, and the pressing of the network button “PC-Link” (button 12 according to FIG. 2) on the network client 6, no further action by the user of the equipment is necessary.

If the procedure for first installation of the network 1 with a single network client 6 has been described above, then the same procedure also applies in the case of several network clients 6, 7, 8 . . . , see also in particular fields 28 and 35 in FIG. 3 where a search is made for network clients as such and the randomly generated SSID2 identification is sent to all network clients, and field 27, where an inquiry is made for any network already in existence with the provisional identification SSID1.

In a modification of the sequence according to FIG. 3, which may be advantageous for additional enhancement of security, field 37, according to which the randomly generated SSID2 is received by the network client 6, is followed by a step in which this SSID2 is modified and sent back to the network server means 3 in the modified form. In a receiving step between fields 35 and 38, the network server means 3 then receive this modified SSID2 and send it if necessary to the other network clients involved (e.g. 7, 8 . . . according to FIG. 1). Such a modification of the SSID2 identification may be made on the basis of a random number determined by the random number generation means 16 in the network client 6, wherein any such random number is simply added to the end of the random SSID2, for example in the form “abcd”-“xyz”. It is however also conceivable for just a model number, type designation, etc. to be appended by the network client 6 to the SSID2 randomly generated by the network server means 3. The only important aspect here is that the “random” network identification generated is as unique as possible, irrespective of whether this is done by the network server means 3 or in cooperation with a network client 6, and that this final network identification SSID2 is known to all devices in the network 1, i.e. in particular the network server means 3 and the network client 6 together with any further network clients 7, 8, . . . , before the provisional network with SSID1 is dismantled and the network with the field identification SSID2 is set up.

FIG. 4 shows in a flow chart, once again on one side for the network server means 3 (on the left) and for the network client 6 (on the right), the procedure for installation of an additional network client, e.g. 7 as shown in FIG. 1, in the case of an already existing network 1 (for example with the SSID2 from just above).

After starting steps in accordance with fields 50 (for the network server means 3) and 51 (for the additional network client 7), then according to field 52 provision is once again made for the additional network client 7 to be attached as close as possible to the access means 4, and according to field 53 the network server means 3 are started up. According to field 54 the additional network client 7 is switched on and the “PC-Link” button 12 on this network client 7 is pressed. While this is done, or before or after, the associated software is again installed on the network server means 3, e.g. from a CD-ROM supplied with them, see field 55 in FIG. 4, and in accordance with field 56 the network server means 3 or the installed software recognize that a network with suitable components already exists. According to an inquiry field 57 it is therefore verified whether or not the current network is the network with identification SSID1, wherein this is assumed to be the identification known to the additional network client 7. In accordance with an inquiry field 57 the network server means 3 determine whether or not the current network has the identification SSID1 and, if so, they search according to field 58 for network clients with this SSID1. If the current network however is not the network with identification SSID1, then the current network is dismantled in accordance with field 59 and a network with the identification SSID1 is set up, see field 59A of FIG. 4.

While this is happening, the additional network client 7 searches according to field 61 for a network with this provisional identification SSID1, wherein according to an inquiry field 61 an inquiry is made as to whether or not such a network with SSID1 has been found. If not, the sequence returns to field 60 and searches further. If however a network with SSID1 is found, the additional network client 7 attempts in accordance with field 62 to log on to this network. Here again there is synchronization with the search step of field 58, in which the network server means 3 search for suitable network clients, and this synchronization is again indicated by a broken line 63 between fields 62 and 58. After an inquiry field 64, in which an inquiry is made as to any elapse of time, the network server means 3 in accordance with field 65 send the final network identification SSID2, already known to them, to the additional network client 7 wherein, in synchronization with this, see the broken line 66 in FIG. 4, the additional network client 7 is in a position of waiting and receiving and also storing this identification SSID2 in accordance with field 67.

In accordance with field 68 the network server means 3 then again close the network with the provisional identification SSID1. The additional network client 7 again, in accordance with field 69, logs off from the network with SSID1, then awaits the network with the final SSID2, to which it logs on, see field 70, as soon as this network with SSID2 has been set up by the network server means 3 in accordance with field 71. This is followed by final steps in accordance with fields 74 and 75 respectively in FIG. 4.

In practice it may also occur that a change has to be made by the network server means 3, for example if a new PC is installed as network server means or new software is loaded. In the event of any such change on the part of the network server means 3, suitable steps are to be taken in respect of the network installation in order to continue the existing network, and the sequence for this purpose is explained below with the aid of FIG. 5.

After a starting step according to field 80 at the network client 6, the network client 6 is switched on in accordance with field 81, and the “PC-Link” button 12 is pressed for example for longer than a preset minimum period, e.g. three seconds or five seconds. This causes the central processor unit 11 in the network client 6 to recognize the difference from a first-time network installation, and the network client 6 searches for the access means 4 with the known MAC address, see field 82 in FIG. 5. In accordance with an inquiry field 83 a check is made as to whether or not such access means 4 have been found. If not, the sequence moves to a final field 84. If however such access means 4 with the known MAC address are found, then the network client 6 checks in the next step, according to field 85, whether or not there is a network with the identification SSID2. If the answer is yes, then the network client 6 breaks off the process, since no change in data is necessary, and it moves to the final step according to field 84. If however no such network with the identification SSID2 exists, then the user is asked, for example on a small display on the network client 6 (not shown in FIG. 2), if he desires re-installation, see field 86 in FIG. 5. If this is not desired, then the network client 6 again—for example automatically after the elapse of a preset time—moves to the final step according to field 84. If however a re-installation is to take place, as confirmed by the user again by longer actuation of the “PC-Link” button 12 (for example for a period of three or five seconds), then the network client 6 puts its identification on the provisional identification SSID1. Here too it is possible to ask if this is really desired, after which the process moves to network installation according to field 87 in FIG. 5, as described above with the aid of FIG. 3, i.e. it passes over to the sequence according to FIG. 3.

In the flow charts which have been explained it is evident that the sequences for the network server means 3 on the one hand and the network client 6 or 7 on the other hand need not necessarily always be absolutely synchronized. Synchronization does occur, though, at the points indicated by the broken lines 33, 36 and 63, 66, namely when the network client 6 or 7, etc. logs on to the—provisional—network with SSID1 and the network server means 3 search for a network client, and when the final random SSID2 is generated by the network server means 3 and sent to the network clients 6, 7, etc., and when on the other hand the network client or clients 6, 7, etc. await the transmission of any such SSID2 identification.

The sequences may also include additional timeout inquiries, for automatic prevention of endless attempts. Essentially however it is possible to incorporate in the central processor unit 11 of the network clients 6, 7, etc. the facility for stopping the process concerned by further pressing of the “PC-Link” button 12 or by simply switching off the network clients 6, 7, etc.

The provisional SSID1 identification may be provided according to the CE equipment type concerned, i.e. a different SSID1 is provided for each model. If for example a network client 6 of equipment type “W 730” is to be installed, then the installation software supplied with this network client 6 contains a different SSID1 from that of the installation software provided with a network client of equipment type “E 530”. By this means it is possible to prevent logging-on to an incorrect network if by chance a network with a consumer electronics device is being installed simultaneously in a neighboring dwelling, since the SSID1 identification—for a different equipment model—will be different.

If in a network 1 the access means 4 are to be replaced, this will have no further effects. The network 1 with the existing. SSID2 will nevertheless be set up via the new access means 4 in the conventional manner. The network client, e.g. 6, only needs to check each time it is switched on, that the MAC address of the access means 4 still agrees with the stored MAC address. If this is not the case, then the new address is to be stored, which may be done without confirmation by the user.

1. A method for automatic assignment of an identification (SSID2) which designates a network (1), in which method network server means (3) and access means (4) connected to these network server means are used, said access means (4) being set up for communication with at least one network client (6), wherein the network server means (3) are operated to generate a network (1) which is defined by a provisional, preset identification (SSID1) known to the network client (6), wherein communication is generated between the network server means (3) and the network client (6) via the access means (4) and the network server means (3) send to the network client (6) a new identification (SSID2) which they have generated, and which is used for final designation of the network (1).

2. A method as claimed in claim 1, in which the network (1) is a wireless network.

3. A method as claimed in claim 1, in which the identification sent by the network server means (3) to the network client (6) is returned to the network server means (3) in modified form, and the identification thus modified is used as final (SSID2) for the network (1).

4. A method as claimed in claim 1, in which the network server means (3) generate the new identification (SSID2) at least pseudo-randomly.

5. A method as claimed in claim 2, in which the network client (6) is attached in the vicinity of the access means (4) for setting-up the network (1) with the provisional identification (SSID1), and the access means (4) are operated in an operating mode with low transmitting power.

6. A method as claimed in claim 1, in which the network server means (3) generate the new identification (SSID2) after they have detected the network client (6) with the provisional, preset identification (SSID1).

7. A method as claimed in claim 1, in which the provisional, preset identification (SSID1) is selected from a group of preset identifications, and the network client (6) has this group of identifications in its memory.

8. A method as claimed in claim 1 in which, to insert an additional network client (7) in the network (1) defined by the final received identification (SSID2), the network server means (3) are operated in order to send out a provisional identification (SSID1) known to the network client (6) and to set up a provisional network with the additional network client (7), after which the network server means (3) inform the additional network client (7) of the final identification (SSID2) already obtained, with which the network (1) is recreated to include the additional network client (7).

9. A method as claimed in claim 8, in which the additional network client (7) is attached in the vicinity of the access means (4) for setting-up the network with the provisional identification (SSID1), and the access means (4) are operated in an operating mode with low transmitting power.

10. A method as claimed in claim 1 in which, during re-installation by the network server means (3), the network client (6) is reset to the provisional, preset identification (SSID1) with which the network server means (3) set up the provisional network, after which the network server means (3) generate a new final identification (SSID2) which they send to the network client (6), and the network (1) is then operated with this identification.

11. System for the automatic setting-up of a network (1) with an identification (SSID2), with network server means (3) to which access means (4) are connected, and with at least one network client (6), wherein the network server means (3) have network driver means (18′) to operate the network with a provisional identification, also identification generation means (17) to generate an identification (SSID2) to be used as final network identification, and wherein the network client (6) has storage means (14) to store at least one provisional identification (SSID1), search means (11′) to search for a network with this provisional identification, also sending and receiving means (13) to receive the identification (SSID2) generated by the network server means (3), together with storage means (14a) to store the identification (SSID2) received from the network server means (3).

12. System as claimed in claim 11, wherein the network (1) is a wireless network.

13. System as claimed in claim 11, wherein the network client has additional code generation means (16) to make an addition to the identification received.

14. System as claimed in claim 11, wherein the identification generation means (16) have random number generation means to generate at least pseudo random numbers.
